(19) United States
(12) Patent Application Publication
(10) Pub. No.: US 2016/0358192 A1
(43) Pub. Date: Dec. 8, 2016

(54) SYSTEMS AND METHODS FOR DETERMINING PUBLIC RELATIONS EVENT IMPACT

(71) Applicant: MASTERCARD INTERNATIONAL INCORPORATED, NEW YORK, NY (US)

(72) Inventors: KENNY UNSER, FAIRFIELD, NY (US); JEAN-PIERRE GERARD, Croton-On-Hudson, NY (US); HARRISON SIEGEL, White Plains, NY (US)

(73) Assignee: MASTERCARD INTERNATIONAL INCORPORATED, NEW YORK, NY (US)

(21) Appl. No.: 14/732,449

(22) Filed: Jun. 5, 2015

(51) Int. Cl. G06Q 30/02

(52) U.S. Cl. CPC G06Q 30/0202; G06Q 30/0201

(57) ABSTRACT

Systems and methods systems are provided for determining the impact of public relations (PR) events on consumer spending. Past PR event information can be identified, and codes characterizing the past PR event information can be applied to standardize and categorize the PR events. The codified past PR event information may then be correlated with transaction data associated with a business or other entity to which the past PR event information is applicable, and one or more factors can be calculated based on the codified past PR event information and transaction data to quantify the impact or influence of the past PR events on past spending behavior. These one or more factors can in turn be applied to new or subsequent PR event information to predict the impact of such new or subsequent PR events on future spending.

### TECHNICAL FIELD

The present disclosure is generally related to electronic transactions. More particularly, the present disclosure is directed to systems and methods for predicting the impact of public relations (PR) events on consumer spending behavior through the use of electronic transaction data.

### BACKGROUND

Businesses often engage in goodwill activities, such as charitable endeavors intended to raise the profile of the business in consumers' eyes and create positive impressions on its existing and/or potential consumer base. Similarly, businesses may engage in campaigns to address public perception in response to events that may be viewed by consumers as being negative, such as product recalls, scandals involving company executives, etc. Such PR activity is often geared towards cultivating and/or repairing customer brand loyalty. However, although the use of payment cards for a broad spectrum of cashless transactions has become ubiquitous in the current economy, accounting for hundreds of billions of dollars in transactions during a single year, mechanisms that allow transaction data and PR events to be tied together do not exist. As such, businesses are unable to quantify the financial effects of PR events and are limited to blindly responding to PR events without a clear understanding of how PR events actually impact spending behavior.

### SUMMARY

In accordance with one embodiment, a method comprises codifying historical PR event information associated with a historical PR event, and computing one or more impact factors relevant to the codified historical PR event information based on historical transaction data. The method further comprises codifying new PR event information associated with a new PR event, and associating at least one of the one or more impact factors with the codified new PR event information to predict an impact of the new PR event on future spending.

In accordance with another embodiment, a non-transitory computer-readable medium has computer executable program code embodied thereon. The computer executable program code is configured to cause a computer system to obtain historical event information relevant to a plurality of acts previously associated with a first entity, and assign one or more codes characterizing the historical event information. The computer executable program code is configured to further cause the computer system to compute one or more impact factors based on historical transaction data corresponding to the historical event information and associate each of the one or more impact factors with each of the one or more codes characterizing the historical event information. The computer executable program code is also configured to cause the computer system to obtain new event information relevant to at least one new act associated with at least one of a second entity and the first entity, assign one or more codes characterizing the new event information, and associate at least one of the one or more impact factors with the each of the one or more codes characterizing the new event information.

In accordance with still another embodiment, a system comprises a data processing engine adapted to extract historical PR event information associated with a historical PR event. The system further comprises an impact engine adapted to: codify the historical PR event information; compute one or more impact factors relevant to the codified historical PR event information based on historical transaction data; codify new PR event information associated with a new PR event; associate at least one of the one or more impact factors with the codified new PR event information; and predict an impact of the new PR event on future spending based upon correlating the one or more impact factors associated with the codified new PR event information to at least one of the historical transaction data and current transaction data.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates an example payment card transaction processing system.

FIG. 2 illustrates an example PR impact prediction system in accordance with various embodiments.

FIG. 3 is a flow chart illustrating various operations that may be performed to codify historical PR events and compute applicable impact factors in accordance with various embodiments.

FIG. 4 is a flow chart illustrating various operations that may be performed to codify new PR events and predict the impact of the new PR events in accordance with various embodiments.

FIG. 5 illustrates example data structures utilized in predicting the impact of PR events in accordance with various embodiments.

FIG. 6 illustrates an example computing module that may be used in implementing features of various embodiments.

The drawings are described in greater detail in the description and examples below.

### DETAILED DESCRIPTION

The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As alluded to previously, businesses often engage in various types of activities in an effort to create a positive public image of the business in the eyes of consumers, whether the consumers are existing customers or potential customers of the business. For example, a business may make public announcements regarding charitable donations made on behalf of a popular cause or may publicly announce some policy change believed to engender positive perceptions regarding the business. In other instances, a business may try to counteract or reverse the adverse effects associated with a negatively-perceived PR event, such as a product recall. That is, the business may offer free replacements for the recalled product so as to avoid losing existing customers and/or avoid turning off potential customers. Still other PR events may involve public announcements regarding a particular political view(s) taken by an executive of a company, which may positively resonate with certain consumers (e.g., those with similar political views), but which may repel other consumers (e.g., those with differing political views).

In any of the aforementioned scenarios, it would be useful for a business (or other entity for which revenue or receiving monies is of import) to have the ability to tie consumer spending behavior to a PR event. In this way, the business could determine an actual impact of the PR event on spending behavior. That is, the business could assess and/or forecast the financial impact of one or more PR events thereby quantifying the one or more PR events and allowing the business to more accurately determine how to represent itself to consumers and/or effectively react to the one or more PR events.

Accordingly, various embodiments of the technology disclosed herein are directed to systems and methods of determining the impact of PR events on consumer spending. In particular, past PR events can be identified, and information regarding and/or applicable to the PR events can be stored. A codifying scheme can be applied to the PR events information in order to standardize and categorize the PR events or one or more aspects of the PR events. The codified PR event information may then be correlated with transaction data associated with a business or other entity to which the PR event information is applicable, and one or more factors can be calculated based on the codified PR event information and transaction data to quantify the impact or influence of the past PR events on past spending behavior. These one or more factors can in turn be stored and applied to new or subsequent PR events to predict the impact of such new or subsequent PR events on future spending. That is, past PR events can be compared to new PR events to determine any similarities, and the impact of past PR events on past spending behavior can be used to predict how the new PR events will affect future spending.

It should be noted that embodiments of the technology disclosed herein can be applied to a variety of scenarios. For example, PR event impact prediction can be used, not only for businesses seeking to avoid losses in revenue, but also for entities such as charitable organizations that may rely on PR event impact prediction to, e.g., determine a return on investment with regard to fund-raising campaigns or initiatives. Moreover, the results of such PR event impact prediction can be extrapolated to determine public perception regarding a particular PR event or type of PR event. That is, conventional methods of polling may result in inaccuracies because information gleaned from polling merely relies on, e.g., self-reporting or surveying, whereas spending behavior may be considered to be a more accurate reflection of the impact of a PR event. It should be further noted that PR events as utilized herein can refer to any type of event, undertaking, or activity performed by an entity that may impact the perception of that entity, whether the impact is felt from the public at large, some smaller subset of the population, private individuals or entities, etc.

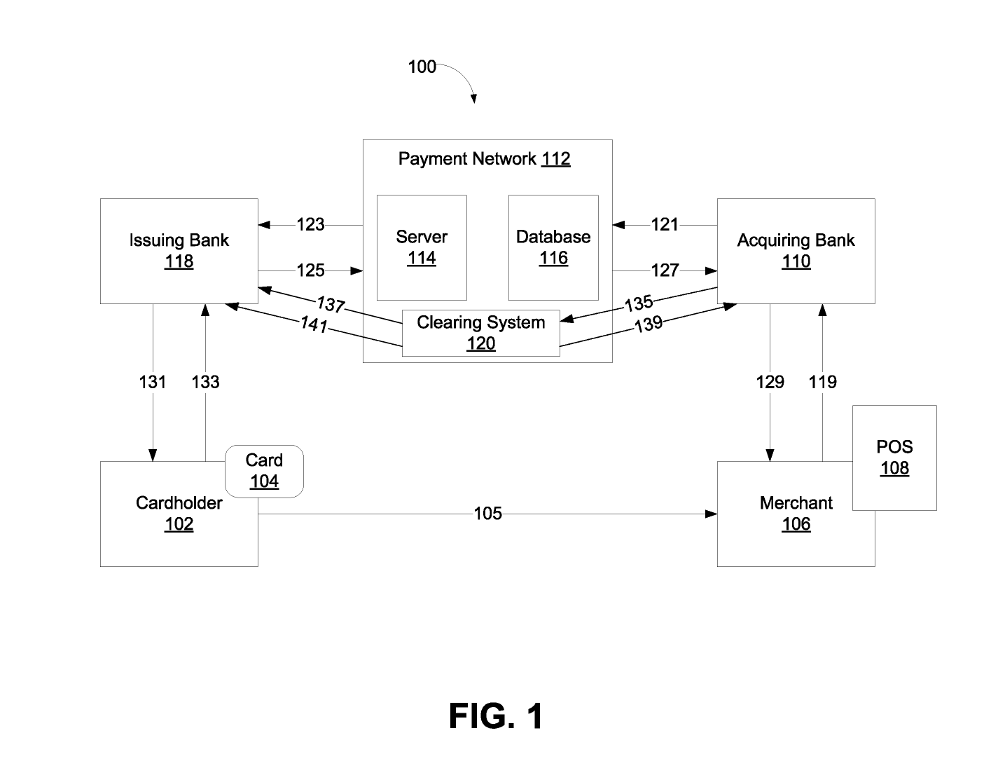

FIG. 1 depicts an example payment card transaction processing system 100. In a typical card-based payment system transaction, a cardholder 102 presents a credit/debit/prepaid card 104 to a merchant 106 for the purchase of goods and/or services. This transaction is indicated by arrow 105. A “card” 104, as used herein, can refer to a conventional magnetic-stripe credit, debit card, or similar proximity payment device (utilized on its own or incorporated into another device such as a mobile telephone, personal digital assistant (PDA), etc.) having near field communications (NFC) capabilities, such as a radio frequency identification (RFID) chip implemented therein. A “card” 104 can further refer to virtual or limited use account numbers and electronic wallets.

It is understood that prior to the occurrence of such a transaction, cardholder 102 was issued card 104 by an issuing bank 118. Moreover, it will be understood that merchant 106 has established a relationship with an acquiring bank 110 (also referred to as a merchant bank), thereby allowing merchant 106 to receive cards as payment for goods and/or services. That is, acquiring banks and issuing banks, such as acquiring bank 110 and issuing bank 118, may participate in various payment networks, including payment network 112. One such payment network is operated by MasterCard International Incorporated, the assignee of the present disclosure.

After presentation of card 104 to merchant 106 by cardholder 102, merchant 106 may send an authorization request (indicated by arrow 119) to acquiring bank 110 via a point-of sale (POS) terminal 108 located at or otherwise controlled by merchant 106. In turn, acquiring bank 110 communicates with payment network 112 (indicated by arrow 121), and payment network 112 communicates with issuing bank 118 (indicated by arrow 123) to determine whether cardholder 102 is authorized to make transaction 105. The issuing bank 118 either approves or declines the authorization request and thereafter transmits the response back to merchant 106 (indicated by arrows 125, 127 and 129). Merchant 106 may then either complete or cancel transaction 105 based upon the response to the authorization request.

If transaction 105 is approved, in accordance with processes called clearing and settlement, the transaction amount will be sent from issuing bank 118 through payment network 112 to acquiring bank 110. The transaction amount, minus certain fees, will thereafter be deposited within a bank account belonging to merchant 106. Issuing bank 118 thereafter bills cardholder 102 (indicated by arrow 131) for all transactions conducted over a given period of time by sending a cardholder statement to cardholder 102. Cardholder 102 follows by submission of payment(s) (as indicated by arrow 133) to issuing bank 118. This submission of payment(s) (as indicated by arrow 133) by cardholder 102 may be automated (e.g., in the case of debit transactions), may be initiated by cardholder 102 for the exact amount matching amounts of purchases during the statement period (e.g., charge cards or credit balances paid in full), and/or may be submitted (in part or in whole) over a period of time that thereby reflects the amount of the purchases, plus any financing charges agreed upon beforehand between cardholder 102 and issuing bank 118 (e.g., revolving credit balances).

Payment network 112 preferably includes at least one server 114 and at least one database 116. Server 114 may include various computing devices such as a mainframe, personal computer (PC), laptop, workstation or the like. Server 114 can include a processing device and can be configured to implement an authorization and clearance process, which can be stored in computer storage associated with server 114. Database 116 may include computer readable medium storage technologies such as a floppy drive, hard drive, tape drive, flash drive, optical drive, read-only memory (ROM), random access memory (RAM), and/or the like. Server 114 and database 116 may be controlled by software/hardware and may store data to allow it to operate in accordance with aspects of the present disclosure.

POS terminal 108 is in data communication, directly or indirectly, and at least from time to time, with, e.g., an acquirer host computer (not shown) that is part of payment network 112 and is operated for or on behalf of acquiring bank 110, which handles payment card transactions for merchant 106. Server 114 may be operated by or on behalf of the payment network 112, and may provide central switching and message routing functions among the member financial institutions of the payment card network. Issuing bank 118 also preferably makes use of an issuer host computer (not shown), and an access point (not shown) via which the issuer host computer exchanges data messages with server 114. It should be noted that in practice, payment card transaction processing system 100 may involve a large number of cardholders, POS terminals, acquirer host computers, issuer host computers, and access points. In general, the acquirer host computer can receive authorization requests from POS terminals, forward the authorization requests through payment network 112, receive authorization responses, and relay the authorization responses to POS terminal 108. Moreover, the issuer host computer may in general, receive authorization requests from server 114 and transmit authorization responses back to server 114 with respect to the authorization requests.

Clearing (which can happen after transmission of the authorization response if approved) can refer to a process by which issuing bank 118 exchanges transaction information with acquiring bank 110. Acquiring bank 110 can transmit transaction information to a clearing system 120 (indicated by arrow 135). Clearing system 120 can validate the transaction information, and forward it to issuing bank 118 (indicated by arrow 137), which prepares data to be included on a payment statement for cardholder 102. Clearing system 120 may then provide reconciliation to both issuing bank 118 and acquiring bank 110 (indicated by arrows 139 and 141).

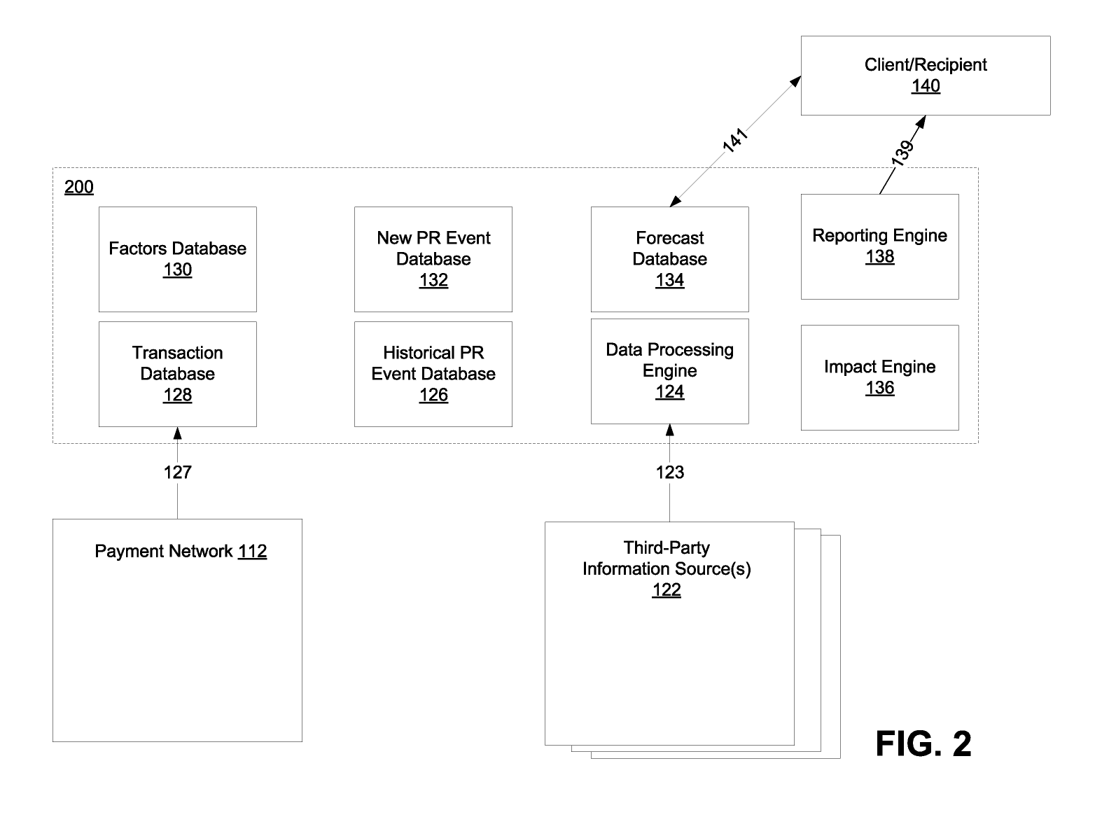

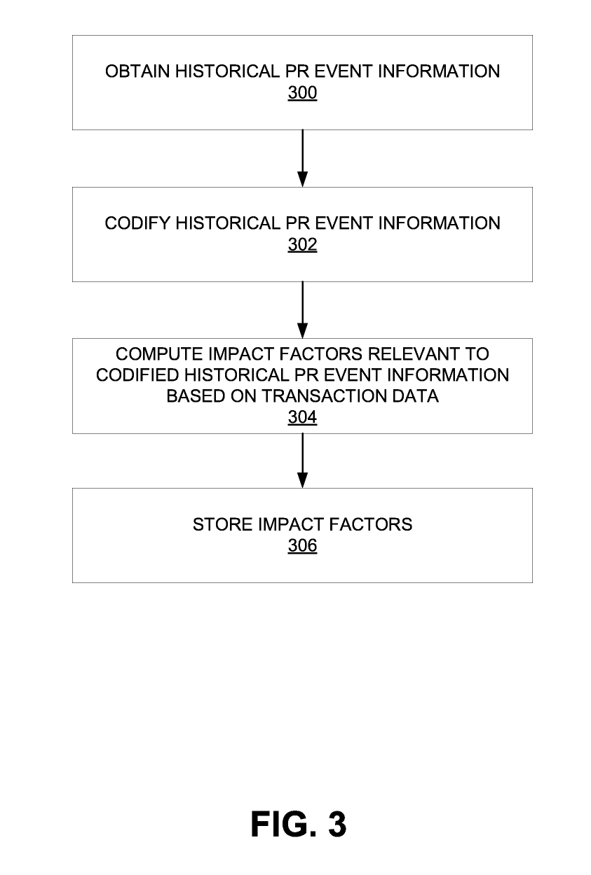

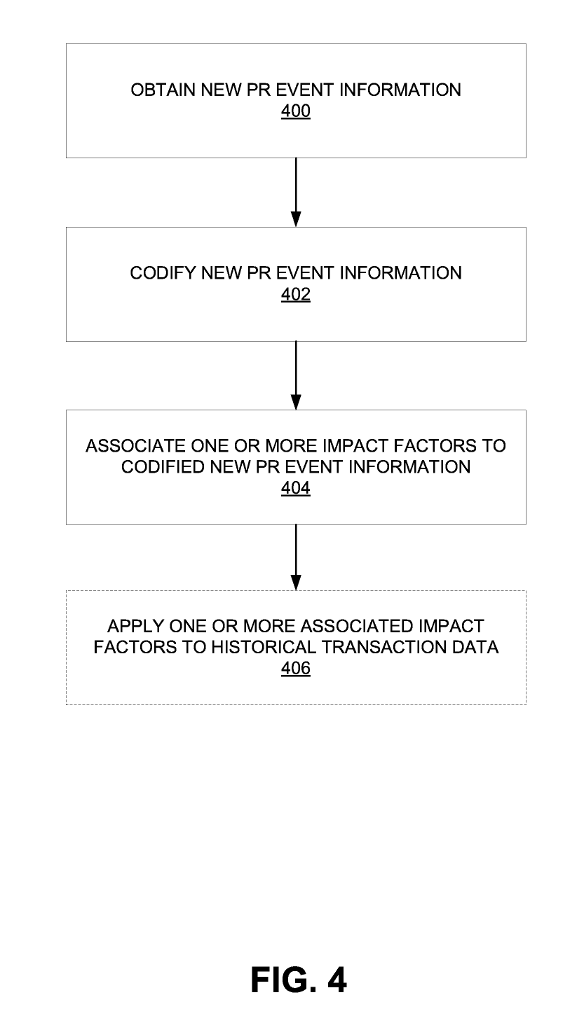

FIG. 2 depicts an example system 200 for predicting the impact of PR events on spending behavior in accordance with various embodiments. FIGS. 3 and 4 are flow charts illustrating example operations that may be performed in accordance with various embodiments for predicting the impact of a PR event. FIGS. 3 and 4 are described in conjunction with and in the context of system 200 for ease of explanation. As described previously, the technology disclosed herein contemplates utilizing transaction data to predict the impact of a PR event(s). To that end, historical PR event information is obtained at operation 300.

Historical PR event information or data can be obtained from one or more third-party information sources 122 and processed by a data processing engine 124 (indicated by arrow 123 and described in greater detail below). Third-party information sources 122 can include one or more of, but not limited to the following: a third-party news aggregator; a parsing process/module; a reporting entity or business that publishes company data; an awards presenter or ranking entity, e.g., Consumer Reports®, a court reporting entity that reports, e.g., public information regarding litigation settlements, a regulatory agency that also publishes reports, e.g., transportation safety reports, mandatory healthcare reports, etc. Other third-party information sources 122 can include, e.g., entities that report firmographic data, such as store locations, annual revenue and earnings statements, employee count, political affiliations (e.g., political action committee (PAC) activity), key company executives, competitors, etc. Still other third-party information sources 122 can include a business or entity itself from which internal business/company information may be reported, as well as internally-tracked raw or aggregated transaction data.

Historical PR event information itself can include, but is not limited to the following: information regarding a charitable partnership; recognition vis-à-vis an industry award, a celebrity product or service endorsement, an executive scandal, a product recall, etc. Historical PR event information can also include a relevant start and/or end date. Moreover, historical PR event information can include related “sub-events,” e.g., national media hits regarding a PR event, information regarding legal proceedings associated with a historical PR event or activity, product or service-related announcements or notifications, such as product recall announcements and/or the implementation or completion of a product recall, public demonstrations or protests, etc. That is, historical PR event information can include any information regarding the historical PR event itself, as well as information associated with any related action or result(s) of the historical PR event.

Historical PR event information that is obtained can be targeted to a specific entity, and/or it can be gathered in an all-inclusive manner to build a knowledge base of historical PR event impact information. That is, historical PR event information associated with a first business or entity may be relevant to that same business or entity upon experiencing a later PR event, as well as to another business or entity that may operate within the same industry, geographical location(s), or that is similar in other ways.

It should be further noted that the historical PR event information obtained from third-party information source(s) 122 may be unstructured and/or received in varying formats. That is, and as described above, the historical PR event information may come in the form of news reports, court documents indicating litigation settlements, etc. Such reports and documents may be formatted in accordance with an electronic/digital format such as a PDF document, or it may be in the form of an HTML-formatted webpage, etc. Accordingly, various embodiments may parse, analyze, or otherwise process historical PR event information from third-party information source(s) 122 to extract relevant data for storage in historic PR event database 126 via data processing engine 134. For example, optical character recognition, natural language processing, and/or other extraction, modeling, and/or contextualization techniques can be applied by data processing engine 134 to obtained historical PR event information in order to recognize and/or format the historical PR event information in a manner that allows it to be utilized by system 200 in predicting PR event impact.

Once historical PR event information is obtained, the historical PR event information can be codified at operation 302. That is, a system of codes can be used to standardize and categorize/characterize the historical PR event information. For example, various historical PR event information can be identified and “labeled” as being, e.g., either a positive or negative event. Receipt of an industry award may be a positive PR event associated with a business, whereas an executive scandal may be designated a negative PR event. PR event information can be characterized as a political PR event, e.g., a company's CEO may announce his/her support for same-sex marriage which can be characterized as a liberal-leaning political PR event, a company may announce the elimination of a union which can characterized as a conservative-leaning political PR event, or a company may publicly promote voter registration which may be characterized as a neutral political PR event. PR event information can also be characterized by type, e.g., a product recall PR event, a charitable partnership PR event, an industry award PR event, etc. It should be noted that historical PR event information can be assigned more than one code as multiple characterizations may apply to a historical PR event. Moreover, codes can be applied to an “overall” PR event, while codes can also be applied to PR sub-events that may result from the overall PR event.

Consider, for example, a PR event involving the CEO of a company changing company policy to eliminate insurance payouts for contraception. Such an event can be codified as being: (1) a politically and/or religiously motivated action; (2) supportive of conservative values; and (3) challenging liberal values. Moreover, public demonstrations arising from an announcement regarding such a policy change can be codified as being: (4) a negative sub-event; and (5) a demonstration sub-event. Though each of these characterizations may summarize the action of the CEO and a resulting sub-event, when viewed along with other PR events categorized in similar ways, it may arise through analysis that, for example, supporting conservative values has the biggest effect on the company's revenue because conservatives are more motivated to align their spending behavior with their values. Liberal-leaning consumers, though perceived to have been slighted by the CEO's action, may be less likely to change their spending behavior in response to the political affiliations of company executives.

Upon codifying the historical PR event information, the codified, historical PR event information can be stored in a historical PR event database 126, and at operation 304, impact factors relevant to the codified, historical PR event information are computed based on transaction data. That is, system 200 communicates with payment network 112 (of FIG. 1) to obtain transaction data processed by payment network 112 (indicated by arrow 123) for storage within a transaction database 124. It should be noted that transaction database 124 can be updated periodically, e.g., as relevant transactions occur, hourly, daily, weekly, etc., or aperiodcally, as may be desired. In accordance with one embodiment, transaction data can be obtained from or upon processing by clearing system 120.

The transaction data that may be obtained from payment network 112 and subsequently stored in transaction database 128 may be, e.g., entire transaction records, or some relevant portion or subset thereof, such as merchant ID, purchase date, and purchase amount information. In accordance with some embodiments, transaction data may be parsed to determine, e.g., a merchant ID, indicative of an entity with which analyzed PR events (described in greater detail below) are related. Transaction data associated with entities that are unrelated to any historical PR events may be discarded or not accessed and stored at all. As with historical PR event information, and in accordance with some embodiments, transaction data to be obtained and/or stored may be predetermined based upon a historical PR event(s) of interest, while in accordance with other embodiments, any and all transaction data resulting from the processing of payment transactions may be obtained and stored. During impact factor computation(s), transaction data can be correlated to any and all relevant, obtained historical PR events in order to build a broader historical knowledge base of the impact of historical PR events. In this way, spending behavior reflected in the transaction data can be associated with a historical PR event in a quantifiable manner, i.e., the computed impact factor can be considered a quantification of the impact or influence of a historical PR event.

For example, and following the above example, a company's CEO may make a public statement reflective of a conservative-leaning political viewpoint, such as the elimination of insurance payouts for contraception. Transaction data may indicate that conservatives are more motivated to align their spending behavior with their values, e.g., a 1% increase in revenue for that company was observed for some amount of time following the announcement of the CEO's public statement. As previously indicated, it can be determined that liberal-leaning consumers, though perceived to have been slighted by the CEO's action, are less likely to change their spending behavior in response to the political affiliations of company executives. Thus, the computed impact factor can be some value, combination of values, or coded indicia that are reflective of this one percent increase in revenue. Other examples of computed impact factors are as follows: company revenue is rarely affected when a company executive is exposed for having participated in an extra-marital affair; maximum positive revenue impact is realized when a company supports a charity that has no political leanings; for an appreciable revenue impact to be seen, a company's charitable contributions must equal at least five percent of the company's total reported earnings.

It should be noted that the transaction data correlated with a historical PR event need not only be transaction data associated with the company associated with the historical PR event. That is, competitor transaction data may also be relevant and thus may also be correlated to the historical PR event. It should further be noted that the computing of impact factors can take into account temporal aspects of a PR event, e.g., by analyzing when a PR event occurred and/or by looking at the impact of a PR event on transaction data on, e.g., a year-to-year or seasonal basis.

The computation of impact factors can be accomplished via impact engine 136 through the use of one or more statistical methods. Such statistical methods may include, but are not limited to: correlation analysis; regression analysis; clustering; decision tree analysis; and Chi-squared Automatic Interaction Detection (CHAID), a specific type of decision tree analysis. Moreover, the accuracy of computed impact factors can be tested against, e.g., a “holdout” sampling of PR events to ascertain whether or not the computed impact factors remain true when applied to distinct, but similar PR events.

At operation 306, the computed impact factors can be stored, e.g., within factors database 130. Over time, and after correlating past transactional data with past PR event information, factors database 130 may become populated with a plurality of computed impact factors indicative of the quantitative effects of historical PR events on spending behavior. As will be described below, these computed impact factors may then be applied to similar or related new/subsequent PR events to predict future spending behavior.

Referring now to FIG. 4, at operation 400, new PR event information is obtained. Obtaining new PR event information can be accomplished in the same or similar manner as that described above with regard to obtaining historical PR event data. That is, new PR event information or data can be obtained from one or more third-party information sources 122 and processed by a data processing engine 124.

At operation 402, the new PR event information is codified, again in a manner that is the same or similar to that described above with respect to historical PR event information, i.e., one or more codes can be assigned to one or more pieces of data indicative or representative of the new PR event information. For example, data processing engine 124 may process new PR event information and extract data indicating that the new PR event is: (1) a public announcement; and (2) made by a company CEO. This new PR event information may be codified by characterizing the new PR event as being: (1) a politically and/or religiously motivated action; (2) supportive of conservative values; and (3) challenging liberal values. The codified new PR event information may be stored in new PR event database 132.

At operation 404, one or more of the previously computed impact factors is associated with the codified new PR event information. For example, impact engine 136 can analyze the codified new PR event information to determine the codes associated with the new PR event information. Upon determining the relevant codes, impact engine 136 can access factors database 130 to obtain those (previously computed) impact factors that are associated with those codes, and the impact of the new PR event can be determined based on the associated impact factors.

At operation 406, the one or more associated impact factors can be applied to historical transaction data maintained in transaction database 128. It should be noted that operation 406 can be an optional operation performed for a variety of reasons. For example, application of the one or more associated impact factors can be performed in order to forecast the impact of the new PR event on future spending behavior. That is, if an associated impact factor suggests that a five percent increase in sales will occur as a result of the new PR event, historical transaction data can be analyzed and a calculation can be performed to determine what that five percent increase in sales might translate into in terms of dollars based on, e.g., the past 5 months of transaction data associated with a particular business. This forecast information may then be stored in forecast database 134. Reporting engine 138 may report a relevant forecast(s) to a client/recipient 140 (indicated by arrow 139), such as the business associated with the new PR event, or a competitor/other business operating in the same industry. Alternatively, the client/recipient 140 may be provided direct access to forecast database 134 to obtain relevant forecast information (indicated by arrow 141) via an appropriate application programming interface (API).

As another example, the impact of a new PR event can be analyzed with respect to one or more merchants that are likely to be impacted. However, all merchants determined as likely to be impacted may not be identified, e.g., as the new PR event unfolds. Accordingly, various embodiments may apply the one or more associated impact factors to historical transaction data in order to predict the impact of the new PR event for additional, previously unidentified merchants. That is, past PR events can be analyzed commensurate with the analysis of new PR events in order to find similar factors that may not necessarily be identified for consideration yet, where the analysis of historical PR events can be an ongoing or recurring/repeating process. It should be noted that the application of the one or more associated impact factors need not be limited to historical transaction data, as relevant transaction data may also include current or recent transaction data that may be associated with a new PR event. Moreover, it should be understood that current or recent transaction data may become historical transaction data over the passage of some amount of time, for example.

It should be further noted that each of databases 124, 126, 128, 130, and 132 may be any type of database suitable for the storage of data as disclosed herein. Each database may store data in a single database, or may store data across multiple databases and accessed through a network. Network configurations as disclosed herein may include a local area network (LAN), a wide area network (WAN), a wireless network (e.g., WiFi), a mobile communication network, a satellite network, the Internet, fiber optic, coaxial cable, infrared, radio frequency (RF) or any other suitable configuration as would be apparent to persons having skill in the relevant art.

Moreover, data may be stored on any type of suitable computer readable media, such as optical storage (e.g., a compact disc, digital versatile disc, blu-ray disc, etc.) or magnetic storage (e.g., a hard disk drive). A database may be configured in any type of suitable database configuration, such as a relational database, a structured query language (SQL) database, a distributed database, an object database., etc. Suitable configurations and database storage types will be apparent to persons having skill in the relevant art.

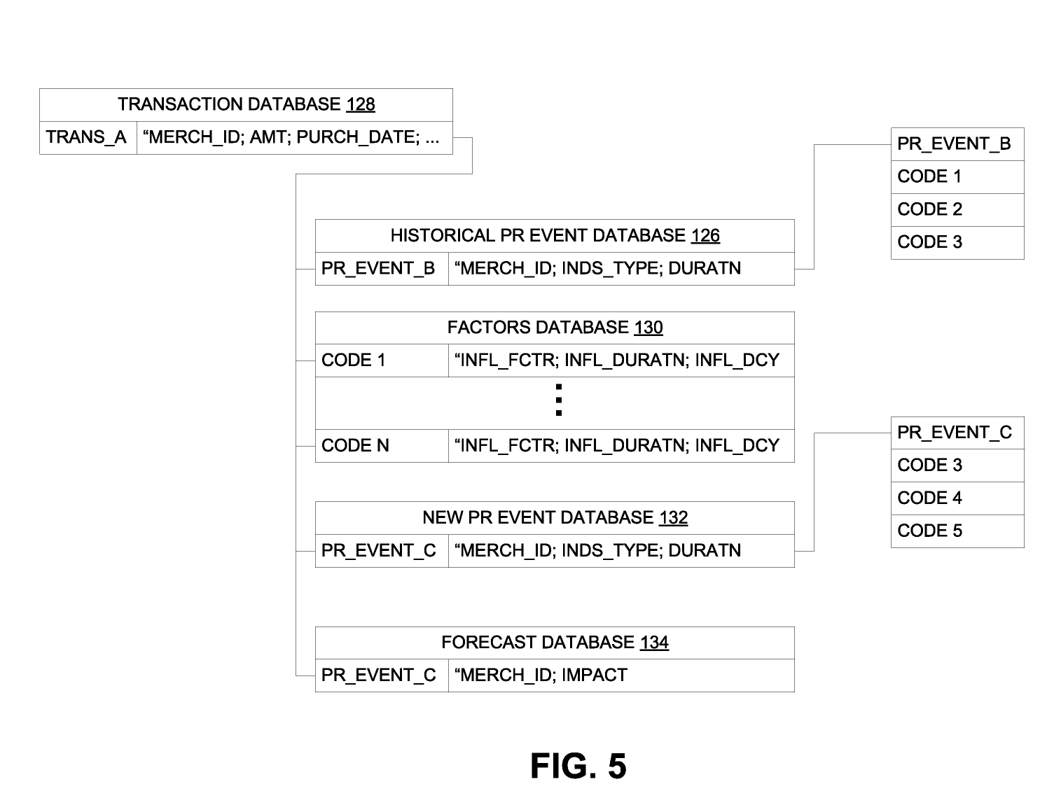

FIG. 5 illustrates example data structures that can be utilized in determining the impact of a PR event in accordance with various embodiments. A plurality of transaction data obtained from payment network 112 may be stored in transaction database 128. A record of a transaction may include, e.g., a merchant ID (“MERCH_ID”), a purchase amount (“AMT”), a purchase date (“PURCH_DATE”), etc. Historical PR event database 126 may store a plurality of PR event information therein. An example of a historical PR event record may include a PR event identifier, in this case, “PR_EVENT_B” as well as an associated merchant ID (MERCH_ID), an industry type associated with the merchant identified by the merchant ID (“INDS_TYPE”) (which may be a Merchant Category Code or “MCC”), and a duration associated with the PR event (“DURATN”), e.g., a start and end date associated with the action giving rise to the PR event. Each PR event record can be codified as described above. FIG. 5 illustrates that PR_EVENT_B is codified with 3 codes (CODE 1, CODE 2, CODE 3) that characterize this particular PR event. It should be noted that the processing requirements for forecasting the effects of new PR events, as well as the storage requirements for historical PR events can be reduced as a result of the above-noted data structures and/or linkages utilized in accordance with various embodiments.

Factors database 130 may have stored therein, a plurality of computed impact factors that reflect a determined impact or influence of a characterized aspect of a PR event. Accordingly, factors database 130 stores computed factor information associated with each code, e.g., a record for CODE 1 can include an influence factor (“INFL_FCTR”), and influence duration (“INFL_DURATN”), and an influence decay (“INFL_DCY”). The influence factor can be some value or indicia reflecting a quantitative impact, such as a ten percent increase in spending, the influence duration can be some value or indicia reflecting how long the impact of a particular PR event aspect lasts, and the influence decay can be some value or indicia reflecting a decline or a “tailing off” of the PR event's effect on transactions. That is, and for example, it may be related to a depression of sales over some duration of time (i.e., the influence duration), or a sharp negative spike in sales sometime within the influence duration. Using correlation techniques, it can be determined that changes in transaction patterns are occurring and such changes can be attributed to PR events. Some examples of influence decay variables may include, but are not limited to a depressed total number of transactions from what is expected, a depressed total spending of what is expected, a lower density of transactions at a given time (for example, if news is released that a restaurant's product is contaminated, far fewer transactions during a peak period such as lunch may be expected). In other words, influence decay can indicate how the effect(s) of a PR event last/diminish over some duration.

New PR event database 132, similar to historical PR event database 126 can store new PR event information regarding a new PR event “PR_EVENT_C” and relevant data, e.g., merchant ID (MERCH_ID), industry type (INDS_TYPE), and duration (DURATN). Also like historical PR event information stored in historical PR event database 126, new PR event information can be codified with appropriate codes, e.g., CODE 3, CODE 4, CODE 5.

Forecast database 134 can store forecasted PR event impact information. In this example, forecasted PR event impact information for PR_EVENT_C is stored, which can include, again, a merchant ID (MERCH_ID), and the forecasted impact, which can include one or more calculated impact factors based upon the codes associated with PR_EVENT_C.

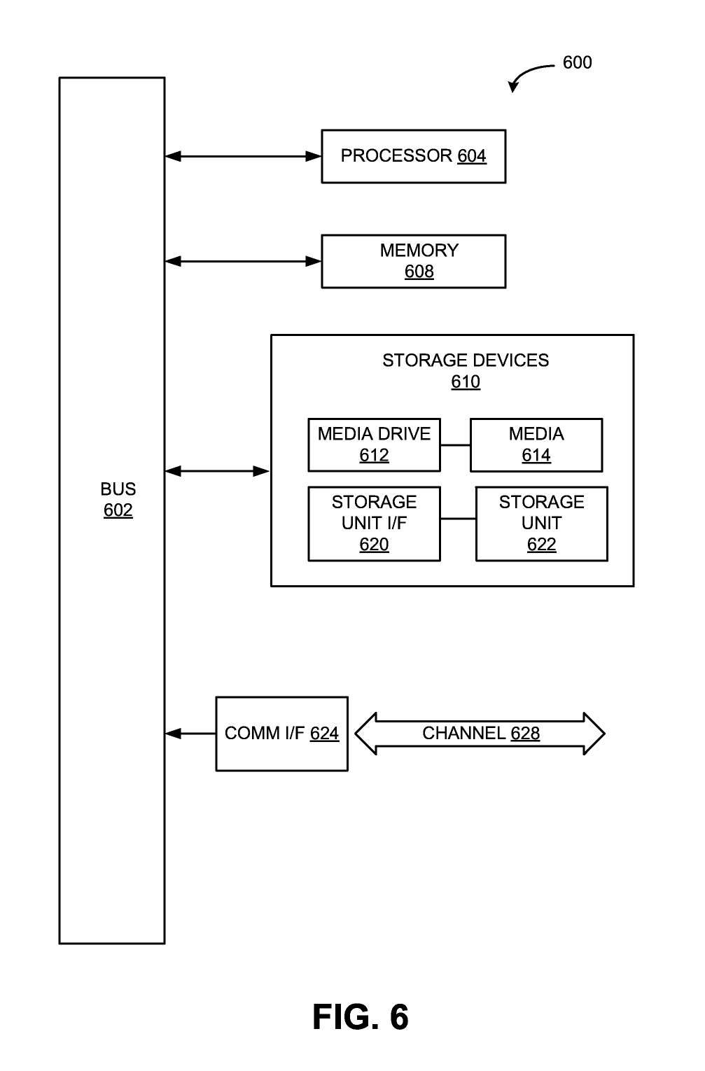

FIG. 6 illustrates an example computing module 600, an example of which may be a processor/controller resident on a computer or server (e.g., data processing engine 124 or impact engine 136 of FIG. 2), that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 might also include one or more memory modules, simply referred to herein as main memory 608. For example, preferably random access memory (RAM) or other dynamic memory might be used for storing information and instructions to be executed by processor 604. Main memory 608 might also be used for storing temporary variables or other intermediate information during execution of instructions to be executed by processor 604. Computing module 600 might likewise include a read only memory (“ROM”) or other static storage device coupled to bus 602 for storing static information and instructions for processor 604.

The computing module 600 might also include one or more various forms of information storage devices 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), or other removable or fixed media drive might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit 622 and a storage unit interface 620. Examples of such storage units 622 and storage unit interfaces 620 can include a program cartridge and cartridge interface, a removable memory (for example, a flash memory or other removable memory module) and memory slot, a PCMCIA slot and card, and other fixed or removable storage units 622 and interfaces 620 that allow software and data to be transferred from the storage unit 622 to one or more components of computing module 600.

Computing module 600 might also include a communications interface 624. Communications interface 624 might be used to allow software and data to be transferred between computing module 600 and external devices. Examples of communications interface 624 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 might typically be carried on signals, which can be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 608, storage unit interface 620, media 614, and channel 628. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing module 600 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
codifying historical PR event information associated with a historical PR event;
computing one or more impact factors relevant to the codified historical PR event information based on historical transaction data;
codifying new PR event information associated with a new PR event; and
associating at least one of the one or more impact factors with the codified new PR event information to predict an impact of the new PR event on future spending.

2. The method of claim 1, further comprising transmitting the predicted impact of the new PR event to a client.

3. The method of claim 1, wherein the historical PR event information is received from one or more third-party information sources.

4. The method of claim 3, further comprising processing the historical PR event information to extract one or more characterizable aspects of the historical PR event.

5. The method of claim 4, wherein codifying the historical PR event information comprises assigning one or more codes indicative of the one or more characterizable aspects of the historical PR event.

6. The method of claim 5, further comprising processing the new PR event information to extract one or more characterizable aspects of the new PR event.

7. The method of claim 6, wherein codifying the new PR event information comprises assigning one or more codes indicative of the one or more characterizable aspects of the new PR event.

8. The method of claim 7, wherein associating the at least one of the one or more impact factors with the codified new PR event information comprises matching the one or more codes indicative of the one or more characterizable aspects of the new PR event with the one or more assigned codes indicative of the one or more characterizable aspects of the historical PR event.

9. The method of claim 1, wherein computing the one or more impact factors comprises determining at least one of influence factor, influence duration, and influence decay values pertinent to the historical transaction data.

10. The method of claim 1, wherein the historical transaction data is obtained from a payment network.

11. A non-transitory computer-readable medium having computer executable program code embodied thereon, the computer executable program code configured to cause a computer system to:
obtain historical event information relevant to a plurality of acts previously associated with a first entity;
assign one or more codes characterizing the historical event information;
compute one or more impact factors based on historical transaction data corresponding to the historical event information and associate each of the one or more impact factors with each of the one or more codes characterizing the historical event information;
obtain new event information relevant to at least one new act associated with at least one of a second entity and the first entity;
assign one or more codes characterizing the new event information; and
associate at least one of the one or more impact factors with the each of the one or more codes characterizing the new event information.

12. The non-transitory computer-readable medium of claim 11, wherein the computer executable program code further causes the computer system to apply the one or more impact factors associated with the one or more codes characterizing the new event information to at least one of the historical transaction data and recent transaction data.

13. The non-transitory computer-readable medium of claim 12, wherein the computer executable program code further causes the computer system to generate a forecasted impact for at least one of the first entity and the second entity based upon the at least one of the one or more impact factors associated with the each of the one or more codes characterizing the new event information.

14. The non-transitory computer-readable medium of claim 11, wherein the historical event information is obtained from at least one of a third-party information source and the first entity.

15. The non-transitory computer-readable medium of claim 11, wherein the historical transaction data is obtained from a payment network.

16. The non-transitory computer-readable medium of claim 11, wherein the one or more impact factors each comprise values or coded indicia indicating at least one of an influence factor, an influence duration, and an influence decay.

17. A system, comprising:
a data processing engine adapted to extract historical PR event information associated with a historical PR event;
an impact engine adapted to:
codify the historical PR event information;
compute one or more impact factors relevant to the codified historical PR event information based on historical transaction data;
codify new PR event information associated with a new PR event;
associate at least one of the one or more impact factors with the codified new PR event information; and
predict an impact of the new PR event on future spending based upon correlating the one or more impact factors associated with the codified new PR event information to at least one of the historical transaction data and current transaction data.

18. The system of claim 17, further comprising a transaction database adapted to receive transaction records from a payment network.

19. The system of claim 17, further comprising a factors database adapted to store the one or more impact factors.

20. The system of claim 17, further comprising a new PR event database adapted to store the codified new PR event information, a historical PR event database adapted to store the codified historical PR event information, and a forecast database adapted to store generated forecasts reflecting the predicted impact of the new PR event on future spending.
